(19) United States
(12) Patent Application Publication
(10) Pub. No.: US 2015/0049392 A1
(43) Pub. Date: Feb. 19, 2015

(54) Zoom lens assembly

(71) Applicants: Sintai Optical (Shenzhen) Co., Ltd., Shenzhen City (CN); Asia Optical International Ltd., Tortola (GB)

(72) Inventors: Chun-Yu Hsueh, Taichung (TW); Tsung-Li Chen, Taichung (TW)

(21) Appl. No.: 14/458,299

(22) Filed: Aug. 13, 2014

(30) Foreign Application Priority Data
Aug. 16, 2013 (TW) 102129425

(51) Int. Cl. G02B 13/00; G02B 15/20; G02B 7/10

(52) U.S. Cl. CPC G02B 13/009; G02B 7/10; G02B 15/20
USPC 359/695

(57) ABSTRACT

A zoom lens assembly includes a focus lens group; a focus motor moving the focus lens group in a zooming operation; a plurality of zoom lens groups; a zoom motor moving the zoom lens groups in a focusing operation; a zoom gear train; a first transmission gear; a second transmission gear; and a transmission element, wherein when a withdrawing operation is performed, the focus lens group is rotated by the zoom motor through the zoom gear train, the first transmission gear, the second transmission gear, and the transmission element so as to avoid the zoom lens group.

### BACKGROUND OF THE INVENTION

1. Field of the Invention

The invention relates to a zoom lens assembly, and more particularly to a zoom lens assembly including a zoom motor driving a focus lens group in a withdrawing operation. 2. Description of the Related Art

Recently, portable electronic devices have become impact and lightweight to facilitate carriage and usage. Therefore, the lens for the portable electronic devices must also be impact and lightweight.

A zoom lens assembly includes a zoom lens group and a focus lens group for zooming operation and focusing operation. For the sake of thinning, a focus motor is utilized to drive the focus lens group during a withdrawing operation. Once the focus lens group contacts a block, the focus lens group rotates and provides a space for the zoom lens group. In such a structure, the focus lens group is rotated by the focus motor. If the focus lens group is too large or too heavy, the focus motor which often has small torque force is unable or difficult to rotate the focus lens group.

### BRIEF SUMMARY OF THE INVENTION

To solve the above problem, the invention provides a zoom lens assembly in which a focus lens group is driven by a zoom motor rather than a focus motor during a withdrawing operation, thereby having broader applications.

The zoom lens assembly in accordance with an exemplary embodiment of the invention includes a focus lens group; a focus motor moving the focus lens group in a zooming operation; a plurality of zoom lens groups; a zoom motor moving the zoom lens groups in a focusing operation; a zoom gear train; a first transmission gear; a second transmission gear; and a transmission element, wherein when a withdrawing operation is performed, the focus lens group is rotated by the zoom motor through the zoom gear train, the first transmission gear, the second transmission gear, and the transmission element so as to avoid the zoom lens group.

In another exemplary embodiment, the second transmission gear is a ring gear which includes an inner protrusion pushing the transmission element during the withdrawing operation.

In yet another exemplary embodiment, the transmission element is L-shaped.

In another exemplary embodiment, the zoom lens assembly further includes a base and a torsion spring, wherein the transmission element is rotatably disposed on the base, and the torsion spring is propped against the base and the transmission element.

In yet another exemplary embodiment, the zoom lens assembly further includes an inner frame and an outer frame, wherein the focus lens group is fixed to the inner frame which is rotatably disposed on the outer frame, and during the withdrawing operation the transmission element pushes the inner frame to rotate the inner frame and the focus lens group.

In another exemplary embodiment, the inner frame includes an extension portion pushed by the transmission element during the withdrawing operation.

In yet another exemplary embodiment, the zoom lens assembly further includes a torsion spring propped against the inner frame and the outer frame.

In another exemplary embodiment, the first transmission gear is a spool gear.

The invention further provides a zoom lens assembly. The zoom lens assembly in accordance with an exemplary embodiment of the invention includes a focus lens group; a plurality of zoom lens groups; a motor moving the zoom lens groups in a zooming operation and rotating the focus lens group to avoid the zoom lens group in a withdrawing operation; a zoom gear train; a first transmission gear; a second transmission gear; and a transmission link, wherein when a withdrawing operation is performed, the focus lens group is rotated by the motor through the zoom gear train, the first transmission gear, the second transmission gear and the transmission element.

In another exemplary embodiment, the zoom lens assembly further includes an inner frame and an outer frame, wherein the focus lens group is fixed to the inner frame which is rotatably disposed on the outer frame, and during the withdrawing operation the transmission element pushes the inner frame to rotate the inner frame and the focus lens group.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a zoom lens assembly of the invention stretching out for shooting;

FIG. 2 depicts a zoom lens assembly of the invention retracted for withdrawing operation;

FIG. 3 depicts elements on a base of a zoom lens assembly of the invention during a withdrawing operation;

FIG. 4 depicts a transmission element not yet driving the focus lens group to rotate;

FIG. 5 depicts a transmission element driving the focus lens group to rotate; and

FIG. 6 is a schematic view of a zoom lens assembly of the invention, with a focus lens frame, an inner frame, an outer frame and a transmission element removed.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

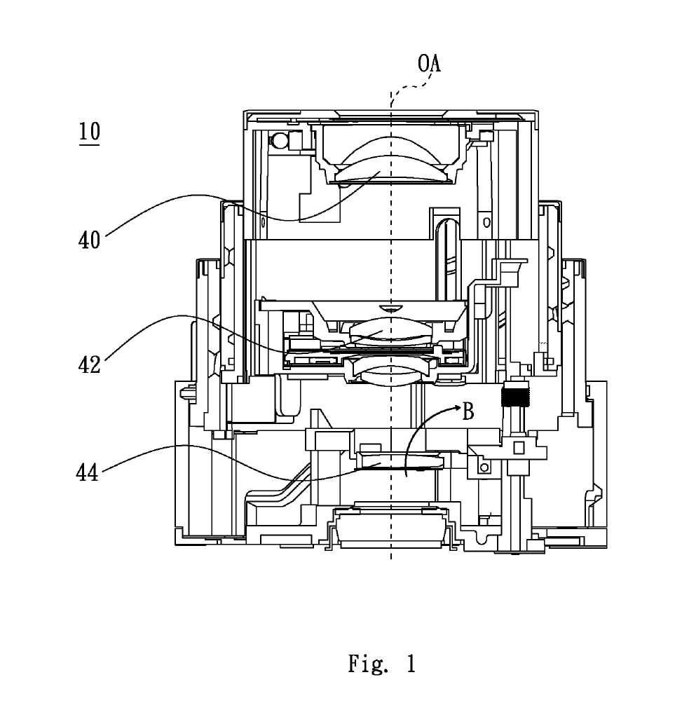

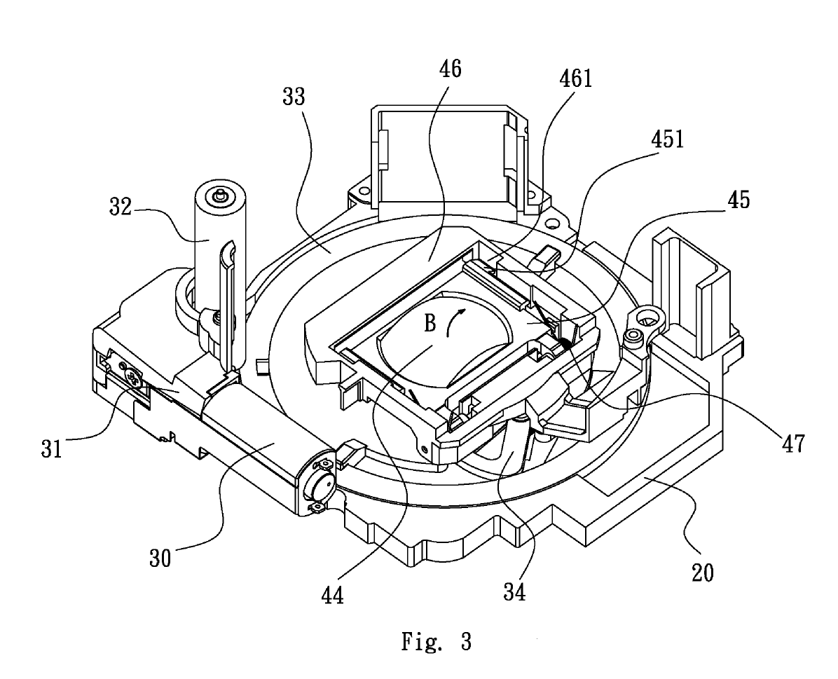

Referring to FIG. 1, in this embodiment, a zoom lens assembly 10 includes a plurality of zoom lens groups 40, 42 and a focus lens group 44. To make a film or photographs, the zoom lens groups 40 and 42 are moved along an optical axis OA by a zoom motor 30 (as shown in FIG. 3) for zooming operation, and the focus lens group 44 is moved along the optical axis OA by the focus motor (not shown) for focusing operation.

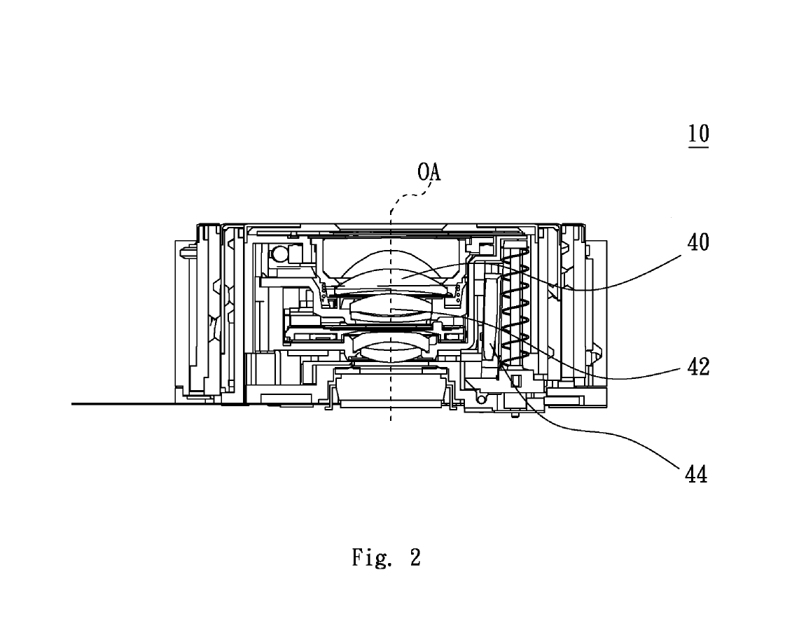

When the zoom lens assembly 10 is not used, withdrawing operation is performed to retract the zoom lens assembly 10, wherein the zoom lens group 40 and 42 and the focus lens group 44 move along the optical axis OA, and the focus lens group 44 rotates in a direction B to provide a space for zoom lens groups 40 and 42. As shown in FIG. 2, because the zoom lens groups 40 and 42 are accommodated in the space, the zoom lens assembly 10 becomes compact and thin.

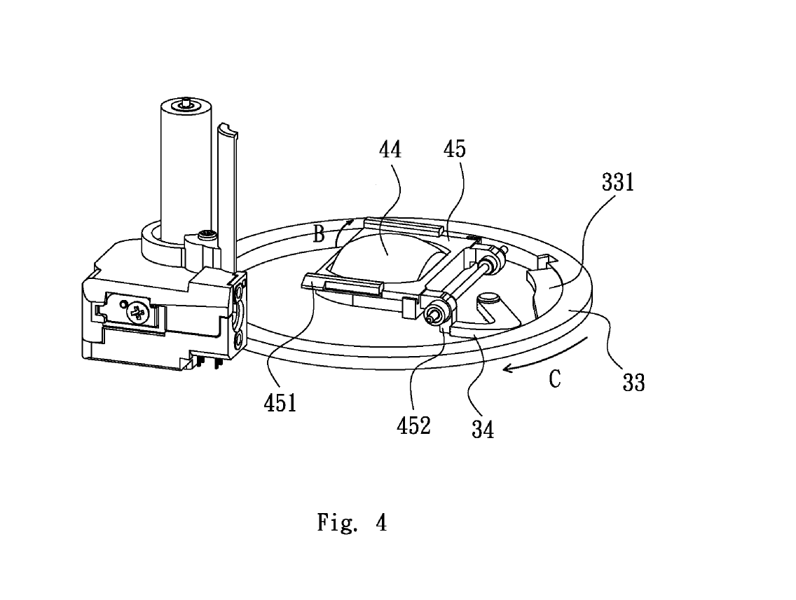

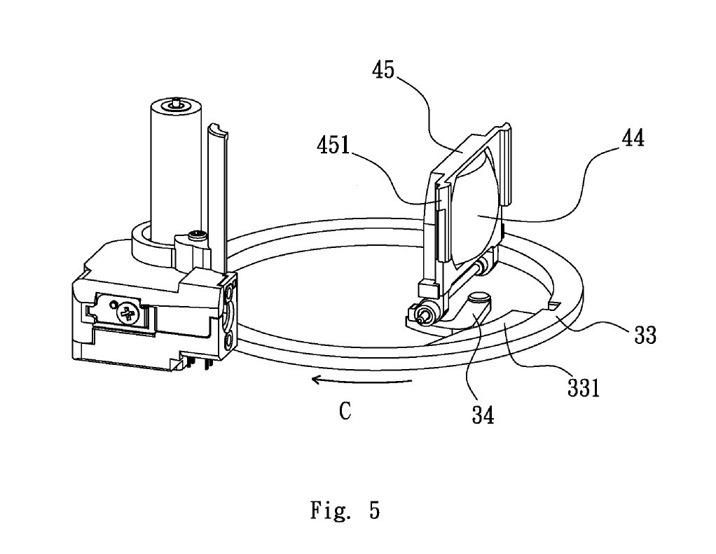

Referring to FIG. 3, the focus lens group 44 is fixed to an inner frame 45 which is rotatably disposed on an outer frame 46. During the withdrawing operation, the focus lens group 44 and the inner frame 45 rotate together, but the outer frame 46 does not rotate. FIGS. 4 and 5 depict the focus lens group 44 and the inner frame 45 rotating in the direction B.

A protrusion 451 is disposed on the inner frame 45, and a groove 461 is correspondingly formed on the outer frame 46. The protrusion 451 engages the groove 461 before the inner frame 45 rotates in the direction B. In addition, a torsion spring 47 is propped against the outer frame 46 and the inner frame 45, whereby the inner frame 45 is positioned in the outer frame 46. When a transmission element 34 pushes the inner frame 45 and overcomes the force of the torsion spring 47, the inner frame 45 starts to rotate.

The rotation of the focus lens group 44 to avoid conflict with the zoom lens groups 40 and 42 is driven by the zoom motor 30 rather than by the focus motor (not shown). Specifically, in a base 20, the zoom motor 30 rotate a second transmission gear (such as a ring gear) 33 through a zoom gear train 31 and the first transmission gear (such as a spool gear) 32. As shown in FIGS. 4 and 5, the second transmission gear 33 rotates in a direction C. An inner protrusion 331 pushes the L-shaped transmission element 34, and the transmission element 34 pushes an extension portion 452 of the inner frame 45 so that the focus lens group 44 and the inner frame 45 rotate in the direction B to avoid the zoom lens group 40 and 42.

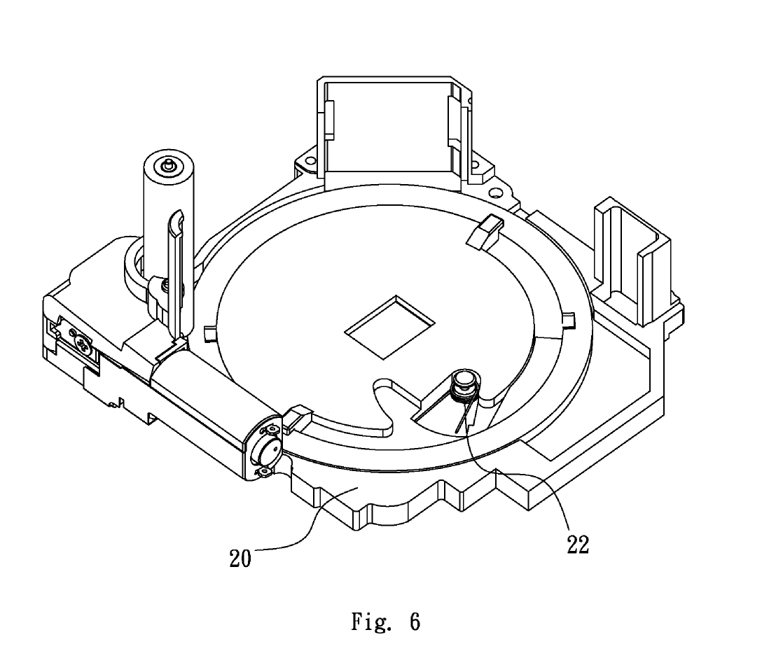

The L-shaped transmission element 34 is rotatably disposed on the base 20. FIG. 6 is a schematic view of a zoom lens assembly of the invention, with the focus lens frame 44, the inner frame 45, the outer frame 46 and the transmission element 34 removed. As shown in FIG. 6, a torsion spring 22 is disposed below the transmission element 34, and the torsion spring 22 is propped against an inner wall of the base 20 and a bottom of the transmission element 34 (not shown). When the transmission element 34 is pushed by the inner protrusion 331 to rotate, the torsion spring 22 deforms. When the inner protrusion 332 leaves the transmission element 34, the transmission element 34 is pushed to its original position under the restoring force of the torsion spring 22.

The invention provides a zoom lens assembly which uses the zoom motor rather than the focus motor to rotate the focus lens group. Therefore, the entire mechanism can be redesigned for broader applications.

In the described embodiment, the zoom motor is used to rotate the focus lens group. However, other designs in which the focus lens group is rotated by different motor and the above redesigned mechanism to avoid conflict between the focus lens group and the zoom lens groups are also included in the scope of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A zoom lens assembly, comprising:
a focus lens group;
a focus motor moving the focus lens group in a zooming operation;
a plurality of zoom lens groups;
a zoom motor moving the zoom lens groups in a focusing operation;
a zoom gear train;
a first transmission gear;
a second transmission gear; and
a transmission element, wherein when a withdrawing operation is performed, the focus lens group is rotated by the zoom motor through the zoom gear train, the first transmission gear, the second transmission gear, and the transmission element so as to avoid the zoom lens group.

2. The zoom lens assembly as claimed in claim 1, wherein the second transmission gear is a ring gear which includes an inner protrusion pushing the transmission element during the withdrawing operation.

3. The zoom lens assembly as claimed in claim 1, wherein the transmission element is L-shaped.

4. The zoom lens assembly as claimed in claim 1 further comprising a base and a torsion spring, wherein the transmission element is rotatably disposed on the base, and the torsion spring is propped against the base and the transmission element.

5. The zoom lens assembly as claimed in claim 1 further comprising an inner frame and an outer frame, wherein the focus lens group is fixed to the inner frame which is rotatably disposed on the outer frame, and during the withdrawing operation the transmission element pushes the inner

6. The zoom lens assembly as claimed in claim 5, wherein the inner frame includes an extension portion pushed by the transmission element during the withdrawing operation.

7. The zoom lens assembly as claimed in claim 5 further comprising a torsion spring propped against the inner frame and the outer frame.

8. The zoom lens assembly as claimed in claim 1, wherein the first transmission gear is a spool gear.

9. A zoom lens assembly, comprising:
a focus lens group;
a plurality of zoom lens groups;
a motor moving the zoom lens groups in a zooming operation and rotating the focus lens group to avoid the zoom lens group in a withdrawing operation;
a zoom gear train;
a first transmission gear;
a second transmission gear; and
a transmission link, wherein when the withdrawing operation is performed, the focus lens group is rotated by the motor through the zoom gear train, the first transmission gear, the second transmission gear and the transmission element.

10. The zoom lens assembly as claimed in claim 9, wherein the second transmission gear is a ring gear which includes an inner protrusion pushing the transmission element during the withdrawing operation.

11. The zoom lens assembly as claimed in claim 9, wherein the transmission element is L-shaped.

12. The zoom lens assembly as claimed in claim 9 further comprising a base and a torsion spring, wherein the transmission element is rotatably disposed on the base, and the torsion spring is propped against the base and the transmission element.

13. The zoom lens assembly as claimed in claim 9 further comprising an inner inner frame which is rotatably disposed on the outer frame, and during the withdrawing operation the transmission element pushes the inner frame to rotate the inner frame and the focus lens group.

14. The zoom lens assembly as claimed in claim 13, wherein the inner frame includes an extension portion pushed by the transmission element during the withdrawing operation.

15. The zoom lens assembly as claimed in claim 13 further comprising a torsion spring propped against the inner frame and the outer frame.

16. The zoom lens assembly as claimed in claim 9, wherein the first transmission gear is a spool gear.
